(19) United States
(12) Patent Application Publication
(10) Pub. No.: US 2017/0291582 A1
(43) Pub. Date: Oct. 12, 2017

(54) RAIN SENSOR WITH MULTI-SENSITIVITY REGION

(71) Applicants: Hyundai Motor Company, Seoul (KR); Kia Motors Corporation, Seoul (KR)

(72) Inventors: Jong Min Park, Seoul (KR); Nak Kyoung Kong, Seongnam (KR); Keon Soo Jin, Ulsan (KR); Ki Hong Lee, Seoul (KR); Jin Sang Lee, Yongin (KR)

(21) Appl. No.: 15/268,760

(22) Filed: Sep. 19, 2016

(30) Foreign Application Priority Data
Apr. 7, 2016 (KR) 10-2016-0042606

(51) Int. Cl. B60S 1/08; G01J 1/04; G01J 1/42

(52) U.S. Cl. CPC B60S 1/0837; G01J 1/4228; G01J 1/0414

(57) ABSTRACT

A rain sensor with a multi-sensitivity region includes: at least one light emitting unit configured to output light; a reflective plate provided to correspond to the at least one light emitting unit at a position spaced apart from the at least one light emitting unit by a predetermined distance; a glass part configured to reflect light reflected by the reflective plate and form a plurality of sensing regions; and a light receiving unit configured to receive the light reflected by the glass part. The reflective plate includes at least one first reflective unit forming a first sensing region and at least one second reflective unit forming a second sensing region, the second sensing region has a quantity of light per unit area higher than a quantity of light per unit area of the first sensing region, and the at least one light emitting unit is disposed at a position corresponding to a focal distance of each of the at least one first reflective unit and at least one second reflective unit.

### CROSS-REFERENCE TO RELATED APPLICATION

This application claims under 35 U.S.C. §119(a) the benefit of and priority to Korean Patent Application No. 10-2016-0042606 filed on Apr. 7, 2016, the entire contents of which are incorporated herein by reference as if fully set forth herein.

### BACKGROUND

### (a) Technical Field

The present disclosure relates generally to a rain sensor with a multi-sensitivity region, and more particularly, to a rain sensor with a multi-sensitivity region in which reflective units having different focal distances are disposed at positions corresponding to a plurality of light emitting units.

### (b) Background Art

A rain sensor, also known as a rain detector or a rain detecting sensor, is a device which can be implemented in a vehicle to automatically sense characteristics, such as the intensity, the amount, etc., of raindrops and control operation, e.g., the speed, the operating time, etc., of a wiper of the vehicle, even when the driver of the vehicle does not manually control the wiper. Notably, if the driver attempts to control the operation or speed of the wiper while driving, the risk of an accident occurring may increase, or the driver may experience inconvenience from turning his/her eyes away from the road or engaging in unnecessary motion. Thus, the rain sensor was created to overcome the foregoing problems.

In detail, the rain sensor is embodied in such a way that, when rainwater falls onto a windshield of a vehicle, the rain sensor installed on a rear surface of the windshield senses the amount and speed of rainwater using infrared rays and controls the windshield wiper to increase or reduce in speed depending on the amount and speed of sensed rainwater. In order to control the speed of the wiper of the vehicle, it is important to accurately measure the amount of rainwater. To improve such accurately, light emitted from a light emitting unit must be efficiently collected. Moreover, because a high sensitivity of the rain sensor may be required depending on the size of a raindrop, there is a problem in that a sensing method using rain sensors having different sensitivities depending on conditions of raindrops may be required.

Conventionally, a rain sensor has measured the amount of rainwater falling onto a glass part in such a way that light emitted from a light emitting unit is directly collected to a light receiving unit, demonstrated in FIG. 1. As shown in FIG. 1, the rain sensor 30 includes a light emitting unit 11 which emits light, a reflective plate 12 which reflects light emitted from the light emitting unit 11, a glass part 20 which re-reflects light reflected by the reflective plate 12 and forms a sensing region, and a light receiving unit 13 which receives light reflected by the glass part 20.

However, in this case, the rain sensor 30 is configured to sense a raindrop having a predetermined size or greater through the configuration in which the light emitting unit and the reflective plate provide a predetermined quantity of light to the sensing region of the glass part. Hence, the conventional rain sensor is problematic in that it cannot provide a sensing region having a high sensitivity for small raindrops. Furthermore, there is a problem in that a separate means for sensing a large raindrop and a small raindrop at the same time is not provided.

The above information disclosed in this Background section is only for enhancement of understanding of the background of the disclosure, and therefore it may contain information that does not form the related art that is already known in this country to a person of ordinary skill in the art.

### SUMMARY OF THE DISCLOSURE

The present disclosure has been made in an effort to solve the above-described problems associated with the related art.

An object of the present disclosure is to provide a rain sensor with a multi-sensitivity region which includes a plurality of sensing regions that can sense a small raindrop and an overall large amount of rainwater at the same time. Another object of the present disclosure is to provide a sensing region which has different sensitivities corresponding to different sizes of raindrops located on a glass part in such a way that a plurality of reflective units having different focal distances are provided such that the quantities per unit area of light beams entering the sensing region of a glass part are different from each other.

According to embodiments of the present disclosure, a rain sensor with a multi-sensitivity region includes: at least one light emitting unit configured to output light; a reflective plate provided to correspond to the at least one light emitting unit at a position spaced apart from the at least one light emitting unit by a predetermined distance; a glass part configured to reflect light reflected by the reflective plate and form a plurality of sensing regions; and a light receiving unit configured to receive the light reflected by the glass part. The reflective plate includes at least one first reflective unit forming a first sensing region and at least one second reflective unit forming a second sensing region, the second sensing region has a quantity of light per unit area higher than a quantity of light per unit area of the first sensing region, and the at least one light emitting unit is disposed at a position corresponding to a focal distance of each of the at least one first reflective unit and at least one second reflective unit.

The focal distance of the at least one first reflective unit may be longer than the focal distance of the at least one second reflective unit.

The focal distance of the at least one first reflective unit may range from approximately 3 mm to approximately 4 mm.

The focal distance of the second reflective unit may range from approximately 5 mm to approximately 10 mm.

A focus of each of the at least one first reflective unit and at least one second reflective unit forming the reflective plate may be determined by: x²=4×f×y, where x denotes a radius of the reflective plate, y denotes a depth of the reflective plate, and f denotes a distance between the at least one light emitting unit and a center of the reflective plate.

The at least one light emitting unit may be configured with two light emitting units disposed at respective positions corresponding to the at least one first reflective unit and at least one second reflective unit.

The quantity of light per unit area may be calculated by an equation of:

$$quantity of light per unit area = \frac{quantity of incident light of light emitting unit}{focal {distance}^{2}} .$$

The at least one light emitting unit may be configured with an infrared light-emitting diode (LED).

The rain sensor may further include a parallel unit disposed on an inner surface of the glass part, wherein the parallel unit may make the light reflected by the reflective plate form parallel light.

The parallel unit may include a serrated lens.

The parallel unit may be provided on the plurality of sensing regions of the glass part and configured to have a bilateral symmetry structure.

The at least one light emitting unit may include two or more light emitting units configured to control light to be received by the light receiving unit through time separation.

Furthermore, according to embodiments of the present disclosure, a vehicle includes: a rain sensor having a multi-sensitivity region; and a control unit having a memory to store program instructions and a processor to execute the stored program instructions, the control unit being configured to control operation of one or more wipers of the vehicle based on information sensed by the rain sensor. The rain sensor having a multi-sensitivity region is configured in the manner described above.

Other aspects and embodiments of the disclosure are discussed infra.

### BRIEF DESCRIPTION OF THE DRAWINGS

The above and other features of the present disclosure will now be described in detail with reference to certain embodiments thereof illustrated the accompanying drawings which are given hereinbelow by way of illustration only, and thus are not limitative of the present disclosure, and wherein:

FIG. 1 is a side sectional view of a conventional rain sensor with a single sensitivity region;

FIG. 2 is a front sectional view of a rain sensor with a multi-sensitivity region, according to embodiments of the present disclosure;

FIG. 3a illustrates an optical path of a first reflective unit forming a first sensing region, according to embodiments of the present disclosure;

FIG. 3b is a side sectional view of the optical path of the first reflective unit forming the first sensing region, according to embodiments of the present disclosure;

FIG. 4a illustrates an optical path of a second reflective unit forming a second sensing region, according to embodiments of the present disclosure;

FIG. 4b is a side sectional view of the optical path of the second reflective unit forming the second sensing region, according to embodiments of the present disclosure;

FIG. 5 is a side sectional view of a reflective plate having different focal distances, according to embodiments of the present disclosure;

FIG. 6 is a graph showing theoretical output loss variation of the path of light traveling in the air as the focal distance is increased according to embodiments of the present disclosure;

FIG. 7 is a graph showing the output per unit area of a path of light traveling in the air as the focal distance is increased according to embodiments of the present disclosure;

FIG. 8 is a graph showing a voltage change rate according to a radius of a raindrop when focal distances are different from each other, according to embodiments of the present disclosure;

FIG. 9 is a graph showing a voltage change rate according to a radius of a raindrop when focal distances are different from each other, according to embodiments of the present disclosure; and

FIG. 10 shows two sensing regions formed on a glass part, according to embodiments of the present disclosure.

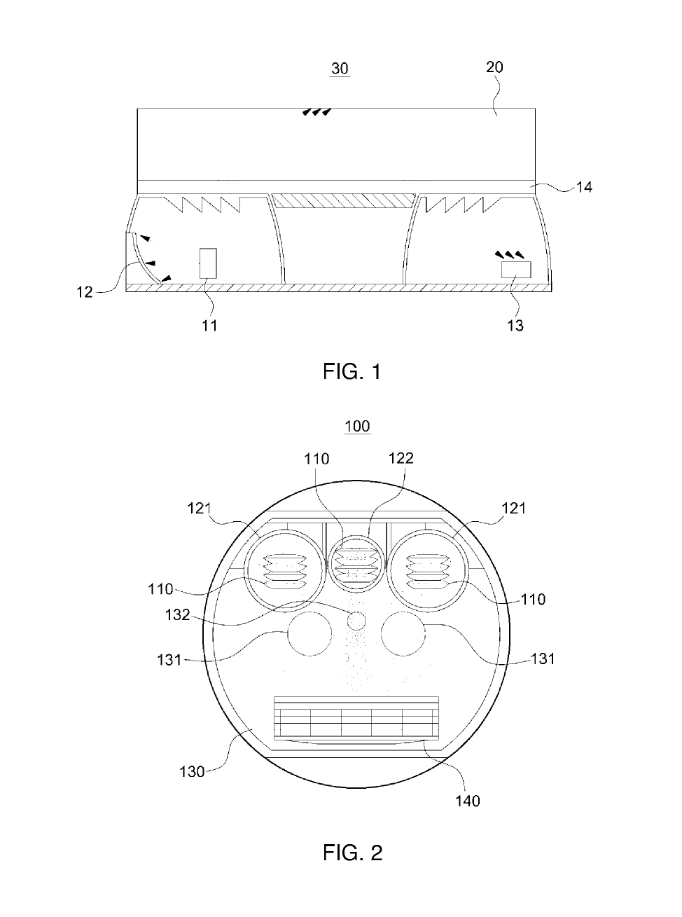

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION OF THE EMBODIMENTS

Hereinafter reference will now be made in detail to various embodiments of the present disclosure, examples of which are illustrated in the accompanying drawings and described below. While the disclosure will be described in conjunction with exemplary embodiments, it will be understood that present description is not intended to limit the disclosure to those exemplary embodiments. On the contrary, the disclosure is intended to cover not only the exemplary embodiments, but also various alternatives, modifications, equivalents and other embodiments, which may be included within the spirit and scope of the disclosure as defined by the appended claims.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. Further, in the following detailed description, names of constituents, which are in the same relationship, are divided into “the first,” “the second,” etc., but the present disclosure is not necessarily limited to the order in the following description. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

Additionally, it is understood that one or more of the below methods, or aspects thereof, may be executed by at least one control unit (not shown). The term “control unit” may refer to a hardware device that includes a memory and a processor. The memory is configured to store program instructions, and the processor is specifically programmed to execute the program instructions to perform one or more processes which are described further below. Moreover, it is understood that the below methods may be executed by an apparatus comprising the control unit in conjunction with one or more other components, as would be appreciated by a person of ordinary skill in the art.

Furthermore, the control unit of the present disclosure may be embodied as non-transitory computer readable media containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed throughout a computer network so that the program instructions are stored and executed in a distributed fashion, e.g., by a telematics server or a Controller Area Network (CAN).

Referring now to the presently disclosed embodiments, the present disclosure relates to a total reflection rain sensor using a mirror which is attached to a glass window of a vehicle and senses raindrops falling onto the vehicle glass window and outputs a signal for controlling the speed and period of a wiper of the vehicle depending on the amount of sensed raindrops and the period of falling of raindrops. Further, the rain sensor may be attached not only to a front windshield of the vehicle but also to any glass window with a wiper among the glass windows of the vehicle (e.g., glass of the rear window).

FIG. 2 is a front sectional view of a rain sensor with a multi-sensitivity region 100, according to embodiments of the present disclosure.

The rain sensor 100 includes at least one light emitting unit 110 which is disposed in a rain sensor housing. The light emitting unit 110 is located on a surface of the housing that is opposite to another surface thereof contacting a glass part 130 of the vehicle, and is oriented to emit light in a horizontal direction of the housing. The light emitting unit 110 may be configured with an infrared LED which emits infrared light. Furthermore, the light emitting unit 110 is configured to face the reflective plate 120 on the same horizontal plane and is disposed such that light emitted from the light emitting unit 110 is reflected by the reflective plate 120.

The rain sensor 100 further includes a light receiving unit 140 which has a configuration corresponding to the light emitting unit 110. The light receiving unit 140 is configured with a photodiode which receives light emitted from the light emitting unit 110. The photo diode is coupled to a PCB 200 disposed in the housing and configured to receive a measured value (voltage change) of light received depending on the amount of rainwater. Furthermore, using the configuration of the PCB 200, the rain sensor 100 is configured to control the speed of the wiper using an output value of received light depending on the amount of rainwater. For instance, in the rain sensor including one or more light emitting units 110, it may be set such that light emitted from the respective light emitting units 110 is time-separated and then is incident on one or more light receiving units 140. That is, this embodiment is configured such that light which is sequentially emitted from at least two light emitting units 110 is sequentially incident on the light receiving unit 140. In this way, the single light receiving unit 140 can receive light emitted from the plurality of light emitting units 110.

Furthermore, a parallel unit 150 may be provided at a position before light is incident on the outside of the glass part 130 of the vehicle. Reflected light may pass through the parallel unit 150 and thus have the form of parallel light. The parallel unit 150 may be symmetrically provided based on the center of a sensing region of the glass part 130 and configured to make not only light entering the glass part 130 but also reflected light to be emitted to the light receiving unit 140 be parallel light. Moreover, reflected light that has passed through the parallel unit 150 may form different type light paths depending on the shape and sensing area of the rain sensor 100.

Furthermore, in the case of the rain sensor 100 having a multi-sensitivity region according to the present disclosure, the reflective plate 120 is configured to have a plurality of reflective units 121 and 122. The reflective units 121 and 122 each have at least one reflective unit and are configured such that different quantities of light are applied to sensing regions 131 and 132 of the glass part 130. In detail, reflected light which is incident on the glass part 130 from the reflective units 121 and 122 is totally reflected at the outside of the glass part 130. For instance, in embodiments of the present disclosure, a first reflective unit 121 and a second reflective unit 122 which have two different focuses are provided, and light emitting unit 110 are disposed at the respective focuses of the reflective units 121 and 122. Light emitted from the light emitting unit 110 is reflected by the reflective units 121 and 122 and is provided as parallel light to the respective sensing regions 131 and 132 of the glass part 130.

The first reflective unit 121 and the second reflective unit 122 which respectively have the different sensing regions 131 and 132 have different focal distances. Depending on the focal distance for the light emitting unit 110, the quantity of light which is incident on the glass part 130 varies. Moreover, due to a difference in the quantity of light which is incident on the glass part 130, a first sensing region 131 is formed by the first reflective unit 121, and a second sensing region 132 is formed by the second reflective unit 122. The sensing regions 131 and 132 formed on the glass part 130 have different areas. The sensing regions 131 and 132 have different quantities of light per unit area. For instance, in embodiments of the present disclosure, the focal distance of the first reflective unit 121 is longer than that of the second reflective unit 122. Thus, the quantity per unit area of light which is incident on the first sensing area 131 formed on the glass part 130 is less than the quantity per unit area of light which is incident on the second sensing area 132 formed by light reflected by the second reflective unit 122.

In this regard, the focus of each of the first reflective unit 121 and the second reflective unit 122 which form the reflective plate 120 is determined by: x²=4×f×y, where x denotes a radius of the reflective plate 120, y denotes the depth of the reflective plate 120, and f denotes the distance between the light emitting unit 110 and the center of the reflective plate 120.

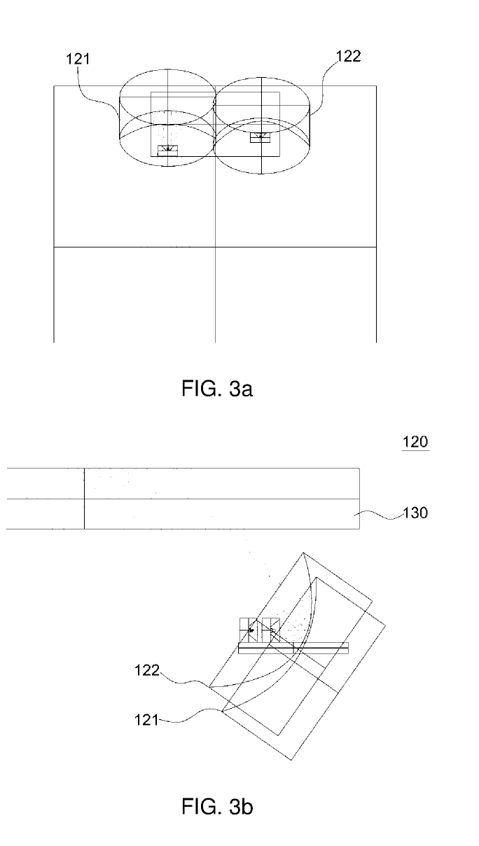

FIGS. 3a and 3b show the path of light formed by the first reflective unit 121 and the light emitting unit 110 corresponding to the first reflective unit 121, according to embodiments of the present disclosure.

As shown in FIG. 3a, the first reflective unit 121 has a focal distance longer than that of the second reflective unit 122. The first reflective unit 121 having the above-mentioned configuration has the first sensing region 131 having a relatively large area formed on the glass part 130, and thus the quantity of light per unit area is less than the quantity of light per unit area of the second sensing region formed on the second reflective unit 122.

As shown in FIG. 3b, light reflected by the first reflective unit 121 forms, at the outside of the glass part 130, the first sensing region 131 having a relatively large area.

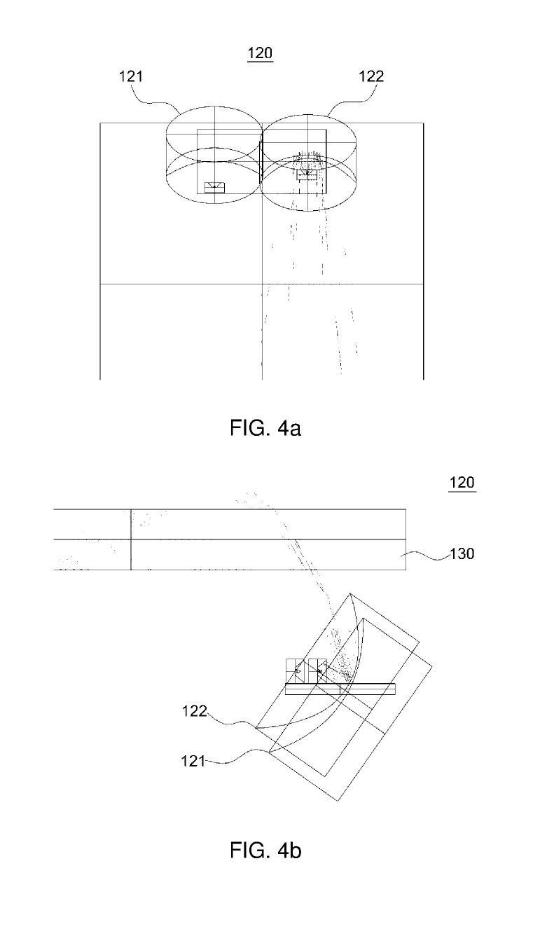

FIGS. 4a and 4b show the path of light formed by the second reflective unit 122 and the light emitting unit 110 corresponding to the second reflective unit 122, according to embodiments of the present disclosure.

As shown in FIG. 4a, the second reflective unit 122 has a focal distance shorter than that of the first reflective unit 121. In the case of the second sensing region 132 formed by the second reflective unit 122, the quantity of light per unit area is greater than that of the first sensing region 131 formed on the first reflective unit 121. That is, as the optical path is formed in a shape in which the width of the path of light which is incident on the reflective plate 120 is relatively small, the density of the quantity of light incident on the second sensing region 132 by the second reflective unit 122 is greater than that of light which is incident by the first reflective unit 121.

FIG. 4b shows the second sensing region 132 formed on the glass part 130 by light reflected by the second reflective unit 122. The second sensing region 132 is smaller than the first sensing region 131 shown in FIG. 3b. The density of light which is incident on the second sensing region 132 is greater than that of light which is incident on the first sensing region 131.

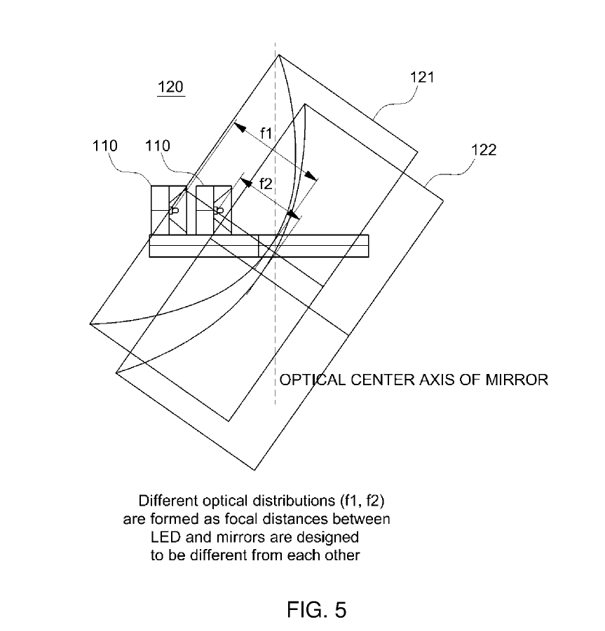

FIG. 5 is a side sectional view of the reflective plate 120 configured with the two reflective units 121 and 122, according to embodiments of the present disclosure.

The focal distance of each of the first reflective unit 121 and the second reflective unit 122 that form the reflective plate 120 is calculated by the following Equation 1. Each focal distance is calculated using the radius of a reflector, the depth of the reflective plate 120, and the distance between the light emitting unit 110 and the center of the reflective plate 120.

x²=4×f×y [Equation 1]

Here, x denotes a radius of the reflective plate 120, y denotes the depth of the reflective plate 120, and f denotes the distance between the light emitting unit 110 and the center of the reflective plate 120. As such, in the present disclosure, the position and the focal distance of the reflective plate 120 can be calculated. Given this, the rain sensor can be configured such that parallel light is incident on the glass part 130 by the configuration in which the light emitting unit 110 is disposed at a position corresponding to the focal distance.

According to Equation 1, the second reflective unit 122 is configured to have a focal distance f2, and the first reflective unit 121 is configured to have a focal distance f1. The light emitting units 110 having configurations corresponding to the respective reflective units 121 and 122 are disposed at positions corresponding to the respective focal distances of the reflective units 121 and 122. Therefore, the optical path formed by the second reflective unit 122 having a focal distance shorter than that of the first reflective unit 121 can form dense incident light.

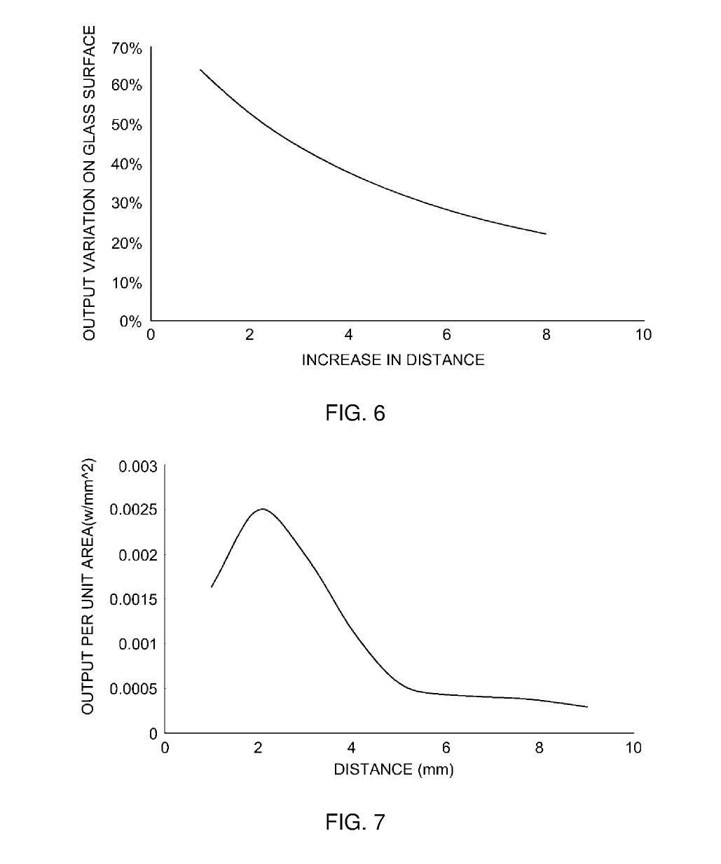

FIG. 6 is a graph showing theoretical output loss variation of the path of light traveling in the air as the focal distance is increased.

The quantity of light per unit area for each sensing region 131, 132 is determined by the quantity of incident light reflected by the reflective plate 120. The quantity of incident light is theoretically determined by the following Equation 2.

$$quantity of light per unit area = \frac{quantity of incident light of light emitting unit}{focal {distance}^{2}} \qquad [ Equation 2 ]$$

As described above, in the present disclosure, the first reflective unit 121 and the second reflective unit 122 are configured to have different focal distances, and the light emitting units 110 are disposed at positions corresponding to the respective focal distances, whereby the quantities of light which is incident on the glass part 130 from the respective reflective units 121 and 122 can differ from each other.

However, the graph shown in FIG. 6 provides the theoretical quantity of light per unit area, as disclosed in Equation 2, and does not take into account an optical loss which is caused by a light source before light reflected by the reflective plate 120 enters the glass part 130.

FIG. 7 shows test data of the output per unit area on the path of light traveling in the air as the focal distance is increased.

Compared to the foregoing graph of FIG. 6, FIG. 7 shows the quantity of light per unit area of the sensing regions 131, 132 which is actually measured depending on an optical loss caused by the light source before light reflected by the reflective plate 120 enters the glass part 130.

In the case where the focal distance d is less than 2 mm, a loss caused by the light source is influential because the distance between the light source and the reflective plate 120 is relatively short. Thus, the quantity (output) per unit area (W/mm²) of reflected light entering the glass part 130 is reduced compared to that of the ideal state. Furthermore, in FIG. 7, it is indicated that when the focal distance of the reflective units 121, 122 is greater than 5 mm, the quantity (i.e., output) of light per unit area (W/mm²) on the sensing region is markedly reduced, so that the sensitivity required to sense a small raindrop cannot be maintained.

Therefore, the second reflective unit 122 according to embodiments of the present disclosure is configured to have a focal distance ranging from at least 2 mm to 5 mm. The second reflective unit 122 having the foregoing configuration can sense a raindrop having a radius of 0.5 mm or less. More preferably, the second reflective unit 122 may have a focal distance ranging from 3 mm to 4 mm. It is noted that the measurements provided herein with respect to the first and second reflective units are approximate.

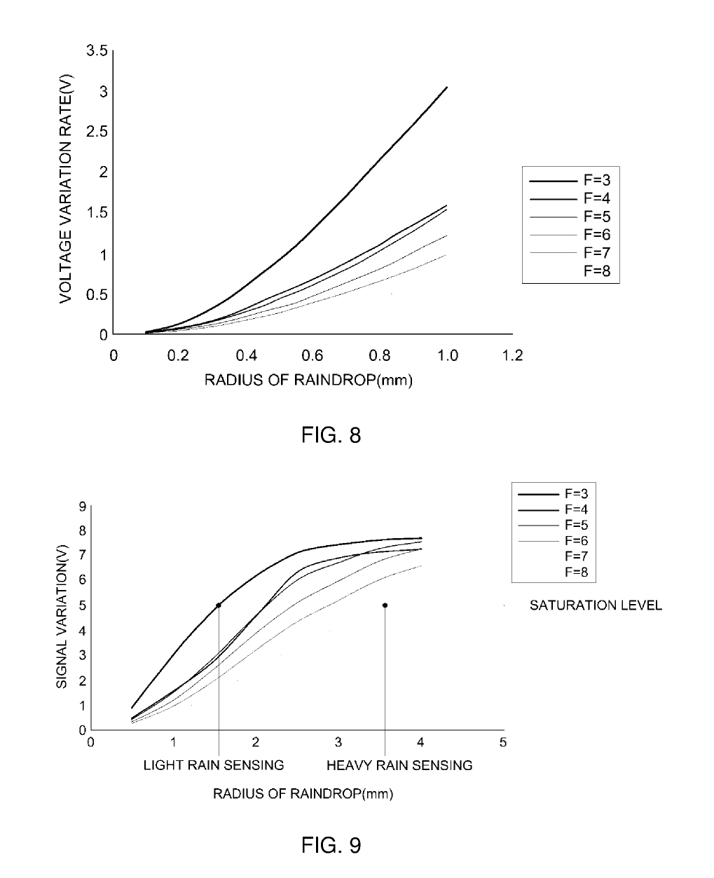

FIG. 8 shows a measured voltage variation rate according to the focal distance of the rain sensor 100 having a multi-sensitivity region according to the present disclosure.

The shown graph indicates variation in output of the rain sensor 100 according to the size of a raindrop by amplifying a change of a signal for rainwater by 2000 times. Here, an output variation value that can be stably obtained may be set to at least 0.5 V.

As shown in the graph, in the case where the focal distance is 3 mm and the radius of a rain drop is about 0.3 mm, a measured voltage variation value is 0.5 V or more. Given this, to sense a raindrop having a radius of 0.3 mm, the second reflective unit 122 is preferably configured to have a focal distance of 3 mm.

Therefore, in embodiments of the present disclosure, each of the first and second reflective units 121 and 122 has a focal distance ranging from 3 mm to 10 mm. More preferably, the second reflective unit 122 may be configured to have a focal distance ranging from 3 mm to 4 mm, and the first reflective unit 121 may be configured to have a focal distance ranging from 5 mm to 10 mm. In this case, the rain sensor 100 can sense a raindrop having a radius of 0.3 mm and can also sense a raindrop having a radius of 0.6 mm or more.

FIG. 9 is a saturation level graph showing an output signal variation depending on the radius of a raindrop according to embodiments of the present disclosure.

In the rain sensor 100 of the present disclosure, in the case where the output signal variation rate is converted to a voltage level by multiplying it by 2000 times, it is possible to sense a raindrop when the output signal variation rate is a value of 5 V or less, but it is difficult to detect a signal variation when the output signal variation rate is greater than 5 V. Furthermore, in the case of a reflective unit having a long focal distance, because there is no rapid signal variation, it is suitable for sensing a raindrop having a radius of 1 mm or more.

Due to the foregoing configuration, in the case of the first reflective unit 121 having a focal distance ranging from 5 mm to 10 mm, the first sensing region 131 formed by the first reflective unit 121 can be formed to accurately sense a raindrop having a radius of 1 mm or more.

Furthermore, as the second reflective unit 122 of the present disclosure is configured to have a focal distance ranging from 3 mm to 4 mm, the second sensing region 132 formed by the second reflective unit 122 can be formed to sense a raindrop having a radius of 1 mm or less.

As described above, the present disclosure includes the first sensing region 131 and the second sensing region 132 and thus can provide the rain sensor 100 which can sense both a dewdrop (a raindrop having a radius of 1.5 mm or less) formed on the glass part 130 and a raindrop having a radius ranging from 1.5 mm to 3.5 mm.

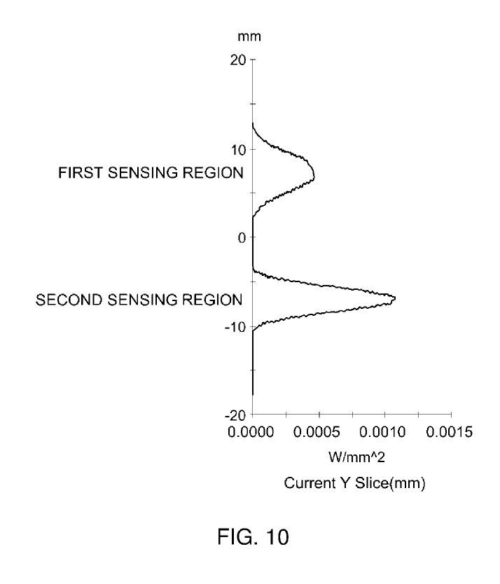

FIG. 10 shows irradiance on the sensing regions 131 and 132 formed on the glass part 130, as the embodiment of the present disclosure.

In detail, the graph of FIG. 10 illustrates irradiance of the first sensing region 131 and the second sensing region 132 formed on the glass part 130 according to the rain sensor 100 in which the second reflective unit 122 has a focal distance of 3 mm and the first reflective unit 121 has a focal distance of 6 mm, as the embodiment of the present disclosure.

That is, in the case of the second sensing region 132, reflected light is incident on a small area compared to that of the first sensing region 131, and the output value is higher than that of the first sensing region 131. In the graph, it is shown that the output value on the second sensing region 132 is 0.0010 (W/mm²). Compared to this, the first sensing region 131 has a larger area compared to that of the second sensing region 132, but the output value on the first sensing region 131 is 0.0003 (W/mm²).

As such, the first sensing region 131 formed by the first reflective unit 121 is capable of sensing a raindrop having a radius ranging from 0.6 mm to 3 mm, and simultaneously the second sensing region 132 formed by the second reflective unit 122 is capable of sensing a raindrop having a radius ranging from 0.3 mm to 1 mm.

As is apparent from the above description, a rain sensor with a multi-sensitivity region according to the present disclosure has the following effects.

The rain sensor according to the present disclosure includes a sensing region having high sensitivity and thus is able to precisely sense a raindrop having a relatively small size. Furthermore, the rain sensor can sense a raindrop having a small size and, simultaneously, sense a raindrop having a large size. Therefore, the rain sensor of the present disclosure can provide greater accuracy. Moreover, because the rain sensor of the present disclosure has high accuracy, it can accurately control the operation of a wiper depending on driving conditions, thus improving the visibility and safety of a driver.

The disclosure has been described in detail with reference to embodiments thereof. However, it will be appreciated by those skilled in the art that changes may be made in these embodiments without departing from the principles and spirit of the disclosure, the scope of which is defined in the appended claims and their equivalents.

What is claimed is:

1. A rain sensor with a multi-sensitivity region, comprising:
at least one light emitting unit configured to output light;
a reflective plate provided to correspond to the at least one light emitting unit at a position spaced apart from the at least one light emitting unit by a predetermined distance;
a glass part configured to reflect light reflected by the reflective plate and form a plurality of sensing regions; and
a light receiving unit configured to receive the light reflected by the glass part, wherein
the reflective plate includes at least one first reflective unit forming a first sensing region and at least one second reflective unit forming a second sensing region,
the second sensing region has a quantity of light per unit area higher than a quantity of light per unit area of the first sensing region, and
the at least one light emitting unit is disposed at a position corresponding to a focal distance of each of the at least one first reflective unit and at least one second reflective unit.

2. The rain sensor of claim 1, wherein the focal distance of the at least one first reflective unit is longer than the focal distance of the at least one second reflective unit.

3. The rain sensor of claim 1, wherein the focal distance of the at least one first reflective unit ranges from approximately 3 mm to approximately 4 mm.

4. The rain sensor of claim 1, wherein the focal distance of the at least one second reflective unit ranges from approximately 5 mm to approximately 10 mm.

5. The rain sensor of claim 2, wherein a focus of each of the at least one first reflective unit and at least one second reflective unit is determined by: x²=4×f×y, where x denotes a radius of the reflective plate, y denotes a depth of the reflective plate, and f denotes a distance between the at least one light emitting unit and a center of the reflective plate.

6. The rain sensor of claim 1, wherein the at least one light emitting unit includes two light emitting units disposed at respective positions corresponding to the at least one first reflective unit and at least one second reflective unit.

7. The rain sensor of claim 1, wherein the quantity of light per unit area is calculated by an equation of:
$$quantity of light per unit area = \frac{quantity of incident light of light emitting unit}{focal {distance}^{2}} .$$

8. The rain sensor of claim 1, wherein the at least one light emitting unit includes an infrared light-emitting diode (LED).

9. The rain sensor of claim 1, further comprising:
a parallel unit disposed on an inner surface of the glass part,
wherein the parallel unit makes the light reflected by the reflective plate form parallel light.

10. The rain sensor of claim 9, wherein the parallel unit includes a serrated lens.

11. The rain sensor of claim 9, wherein the parallel unit is provided on the plurality of sensing regions of the glass part and configured to have a bilateral symmetry structure.

12. The rain sensor of claim 1, wherein the at least one light emitting unit includes two or more light emitting units configured to control light to be received by the light receiving unit through time separation.

13. A vehicle comprising:
a rain sensor having a multi-sensitivity region; and
a control unit having a memory to store program instructions and a processor to execute the stored program instructions, the control unit being configured to control operation of one or more wipers of the vehicle based on information sensed by the rain sensor,
wherein the rain sensor includes:
at least one light emitting unit configured to output light;
a reflective plate provided to correspond to the at least one light emitting unit at a position spaced apart from the at least one light emitting unit by a predetermined distance;
a glass part configured to reflect light reflected by the reflective plate and form a plurality of sensing regions; and
a light receiving unit configured to receive the light reflected by the glass part, wherein
the reflective plate includes at least one first reflective unit forming a first sensing region and at least one second reflective unit forming a second sensing region,
the second sensing region has a quantity of light per unit area higher than a quantity of light per unit area of the first sensing region, and
the at least one light emitting unit is disposed at a position corresponding to a focal distance of each of the at least one first reflective unit and at least one second reflective unit.
